(19) United States
(12) Patent Application Publication
(10) Pub. No.: US 2014/0067991 A1
(43) Pub. Date: Mar. 6, 2014

(54) DISTRIBUTED STORAGE

(71) Applicants: Joseph SAIB, Santa Clara, CA (US); Jonathan WALLACE, Coral Springs, FL (US)

(72) Inventors: Joseph SAIB, Santa Clara, CA (US); Jonathan WALLACE, Coral Springs, FL (US)

(73) Assignee: APPSENSE LIMITED, Warrington (GB)

(21) Appl. No.: 13/605,026

(22) Filed: Sep. 6, 2012

(51) Int. Cl. G06F 15/167

(52) U.S. Cl. 709/214

(57) ABSTRACT

Systems and methods are described for providing a distributed storage system. A distributed storage system includes a control server coupled to a network, the control server maintaining a policy, a host directory, and a file directory, and a plurality of hosts coupled to the network, each of the plurality of hosts containing a storage device and an agent configured to communicate with the control server, wherein each of the plurality of hosts is configured to contribute a portion of the storage device thereof to collectively form a distributed virtual disk configured to store files, wherein the portion of the storage device on each of the plurality of hosts is configured based on the policy, wherein the host directory contains information about the plurality of the hosts on the distributed storage system, and wherein the file directory contains information about the files stored on the distributed storage system.

### BACKGROUND

Network-Attached Storage (NAS) and Storage Area Network (SAN) are two commonly used network storage technologies, especially in corporate networks. A NAS is generally file-level computer data storage connected to a computer network providing data access to various devices on the computer network. A SAN is generally a dedicated network providing access to consolidated, block level data storage. Both technologies can require separate and dedicated storage resources (e.g., Redundant Array of Independent Disks (RAID)), which are usually expensive to purchase and maintain. In the meantime, many computing devices (e.g., desktop computers) on a network (e.g., a corporate intranet) generally contain their own storage resources (e.g., a hard disk in a desktop computer). These storage resources are usually not fully utilized. For example, a desktop computer with a 100 GB hard disk may only use 20 GB to store its data while the remaining 80 GB of storage space is unutilized and thus wasted. A technology utilizing spare storage resources on networked devices can improve efficiency and lower cost of providing storage on a network.

### SUMMARY

In accordance with the disclosed subject matter, systems and methods are described for providing a distributed storage system.

Disclosed subject matter includes, in one aspect, a distributed storage system which includes a control server coupled to a network, the control server maintaining a policy, a host directory, and a file directory, and a plurality of hosts coupled to the network, each of the plurality of hosts containing a storage device and an agent configured to communicate with the control server, wherein each of the plurality of hosts is configured to contribute a portion of the storage device thereof to collectively form a distributed virtual disk configured to store files, wherein the portion of the storage device on each of the plurality of hosts is configured based on the policy, wherein the host directory contains information about the plurality of the hosts on the distributed storage system, and wherein the file directory contains information about the files stored on the distributed storage system.

In some embodiments, the portion of the storage device on each of the plurality of hosts is a separate partition of the storage device.

In some other embodiments, the policy defines a size of the portion of the storage device on each of the plurality of hosts.

In some other embodiments, the policy further defines whether the size of the portion of the storage device on each of the plurality of hosts is adjustable.

In some other embodiments, the policy defines an availability of each of the plurality of hosts on the distributed storage system.

In some other embodiments, the policy defines access levels among the plurality of hosts on the distributed storage system.

In some other embodiments, at least some of the plurality of hosts on the distributed storage system are separated into one or more groups.

In some other embodiments, the policy defines access levels among the plurality of hosts according to group affiliation information.

Disclosed subject matter includes, in another aspect, a control server for use with a distributed storage system which includes a network and a plurality of hosts, each host including a storage device and an agent. The control server includes a non-transitory memory storing computer readable instructions, a policy, a host directory, and a file directory, and a processor coupled to the non-transitory memory and configured to execute the computer readable instructions, wherein the computer readable instructions are configured to cause the control server to communicate with the agent in each of the plurality of hosts coupled to the network, wherein the computer readable instructions are configured to cause the control server to communicate the policy to the plurality of hosts in order to configure the plurality of hosts, wherein the computer readable instructions are configured to cause the control server to receive an indication from each of the plurality of hosts of a portion of the storage device thereof that is available to form a distributed virtual disk for storing files on the distributed storage system, wherein the host directory contains information about the plurality of the hosts in the distributed storage system, and wherein the file directory contains information about the files stored on the distributed storage system.

In some embodiments, the policy defines a size of the portion of the storage device on each of the plurality of hosts.

In some other embodiments, the policy further defines whether the size of the portion of the storage device on each of the plurality of hosts is adjustable.

In some other embodiments, the policy defines an availability of each of the plurality of hosts in the distributed storage system.

In some other embodiments, the policy defines access levels among the plurality of hosts in the distributed storage system.

In some other embodiments, the policy defines group affiliation of at least some of the plurality of hosts in the distributed storage system.

In some other embodiments, the policy further defines access levels among the plurality of hosts based on the group affiliation.

Disclosed subject matter includes, in yet another aspect, a host for use with a distributed storage system that includes a control server coupled to a network. The host includes a storage device, a non-transitory memory storing computer executable instructions, and a processor coupled to the non-transitory memory and configured to execute the computer readable instructions, wherein the computer readable instructions are configured to cause the host to communicate with the control server, wherein the computer readable instructions are configured to cause the processor to configure the host based on a policy received from the control server, and wherein the computer readable instructions are configured to cause the host to send an indication to the control server of a portion of the storage device thereof that is available to form a distributed virtual disk for storing files on the distributed storage system.

In some embodiments, the computer readable instructions are configured to cause the processor to set a size of the portion of the storage device based on the policy.

In some other embodiments, the computer readable instructions are configured to cause the processor to further set adjustability of the size of the portion of the storage device based on the policy.

In some other embodiments, the computer readable instructions are configured to cause the processor to set availability of the host in the distributed storage system based on the policy.

In some other embodiments, the computer readable instructions are configured to cause the processor to set access levels of the host in the distributed storage system based on the policy.

In some other embodiments, the computer readable instructions are configured to cause the processor to set group affiliation of the host within the distributed storage system based on the policy.

In some other embodiments, the computer readable instructions are configured to cause the processor to further set access levels according to the group affiliation based on the policy.

Disclosed subject matter includes, in yet another aspect, a non-transitory computer readable medium having executable instructions operable to, when executed by a computer, cause the computer to: configure a portion of a storage device of the computer based on a policy maintained by a control server, wherein the control server is coupled to a network and communicates with a plurality of hosts through the network, and contribute the portion of the storage device to form a distributed virtual disk to the plurality of hosts for storing files on a distributed storage system.

Various embodiments of the subject matter disclosed herein can provide one or more of the following capabilities. A distributed storage system can present a distributed virtual disk to various devices on a network. Spare storage resources in a network can be utilized to create a distributed storage system, saving the expense of separate and dedicated storage resources on a network. The distributed storage system can be centrally managed for stronger control or individually configurable for better flexibility.

These and other capabilities of the invention, along with the invention itself, will be more fully understood after a review of the following figures, detailed description, and claims.

### BRIEF DESCRIPTION OF THE DRAWINGS

FIG. 1 illustrates a diagram of an exemplary networked communication system.

FIG. 2 illustrates a block diagram of an exemplary distributed storage system.

FIG. 3 illustrates a block diagram of an exemplary agent in a distributed storage system.

FIG. 4 illustrates a block diagram of an exemplary control server in a distributed storage system.

FIG. 5 illustrates an exemplary host directory in a distributed storage system.

FIG. 6 illustrates an exemplary file directory in a distributed storage system.

FIG. 7 illustrates an exemplary schematic view of a distributed storage system.

FIG. 8 illustrates a block diagram of an exemplary computing system in a distributed storage system.

### DETAILED DESCRIPTION

In the following description, numerous specific details are set forth regarding the systems and methods of the disclosed subject matter and the environment in which such systems and methods can operate in order to provide a thorough understanding of the disclosed subject matter. It will be apparent to one skilled in the art, however, that the disclosed subject matter can be practiced without such specific details, and that certain features, which are well known in the art, are not described in detail in order to avoid complication of the subject matter of the disclosed subject matter. In addition, it will be understood that the examples provided below are only examples, and that it is contemplated that there are other systems and methods that are within the scope of the disclosed subject matter.

Embodiments of the disclosed subject matter can provide techniques for providing a distributed storage system. A distributed storage system can present a distributed virtual disk to various devices on a network. The distributed storage system can be centrally managed by a control server for better control and easy maintenance. The distributed storage system can also be distributedly managed by each individual host for better availability and scalability. The files/data or fragments thereof can be redundantly stored and maintained by multiple hosts for improved reliability and fault tolerance. Each host can be controlled centrally or individually. Various access levels and priorities can be configured to enhance the flexibility and expandability of the distributed storage system. Hosts on the distributed storage system can also be grouped for improved control and usability.

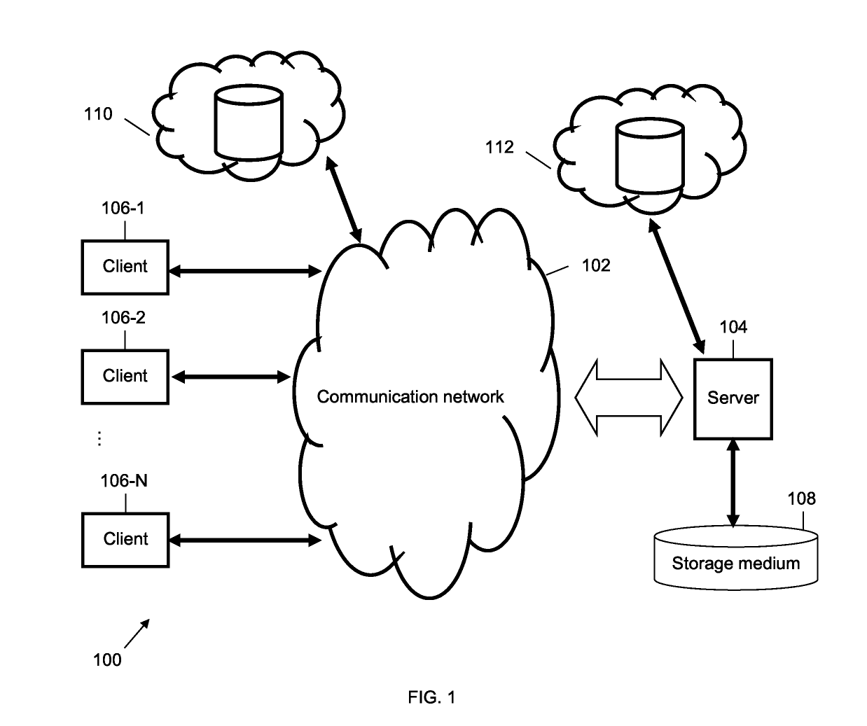

The disclosed subject matter can be implemented in a networked computing system. FIG. 1 illustrates a diagram of a networked communication arrangement 100 in accordance with an embodiment of the disclosed subject matter. The networked communication arrangement 100 can include a communication network 102, a server 104, and at least one client 106 (e.g., client 106-1, 106-2, . . . 106-N), a physical storage medium 108, and a cloud storage 110 and 112.

Each client 106 can communicate with the server 104 to send data to, and receive data from, the server 104 across the communication network 102. Each client 106 can be directly coupled to the server 104; alternatively, each client 106 can be connected to server 104 via any other suitable device, communication network, or combination thereof. For example, each client 106 can be coupled to the server 104 via one or more routers, switches, access points, and/or communication network (as described below in connection with communication network 102). A client 106 can include a desktop computer, a mobile computer, a tablet computer, a cellular device, or any computing systems that are capable of performing computation.

Server 104 can be coupled to at least one physical storage medium 108, which is configured to store data for the server 104. Preferably, any client 106 can store data in, and access data from, the physical storage medium 108 via the server 104. FIG. 1 shows the server 104 and the physical storage medium 108 as separate components; however, the server 104 and physical storage medium 108 can be combined together. FIG. 1 also shows the server 104 as a single server; however, server 104 can include more than one server. FIG. 1 shows the physical storage medium 108 as a single physical storage medium; however, physical storage medium 108 can include more than one physical storage medium. The physical storage medium 108 can be located in the same physical location as the server 104, at a remote location, or any other suitable location or combination of locations.

FIG. 1 shows two embodiments of cloud storage 110 and 112. Cloud storage 110 and/or 112 can store data from physical storage medium 108 with the same restrictions, security measures, authentication measures, policies, and other features associated with the physical storage medium 108. FIG. 1 shows the cloud storage 112 separate from the communication network 102; however, cloud storage 112 can be part of communication network 102 or another communication network. The server 104 can use only cloud storage 110, only cloud storage 112, or both cloud storages 110 and 112. FIG. 1 shows one cloud storage 110 and one cloud storage 112; however, more than one cloud storage 110, more than one cloud storage 112 or any suitable combination thereof can be used.

The communication network 102 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks may be implemented with any number of hardware and software components, transmission media and network protocols. FIG. 1 shows the network 102 as a single network; however, the network 102 can include multiple interconnected networks listed above.

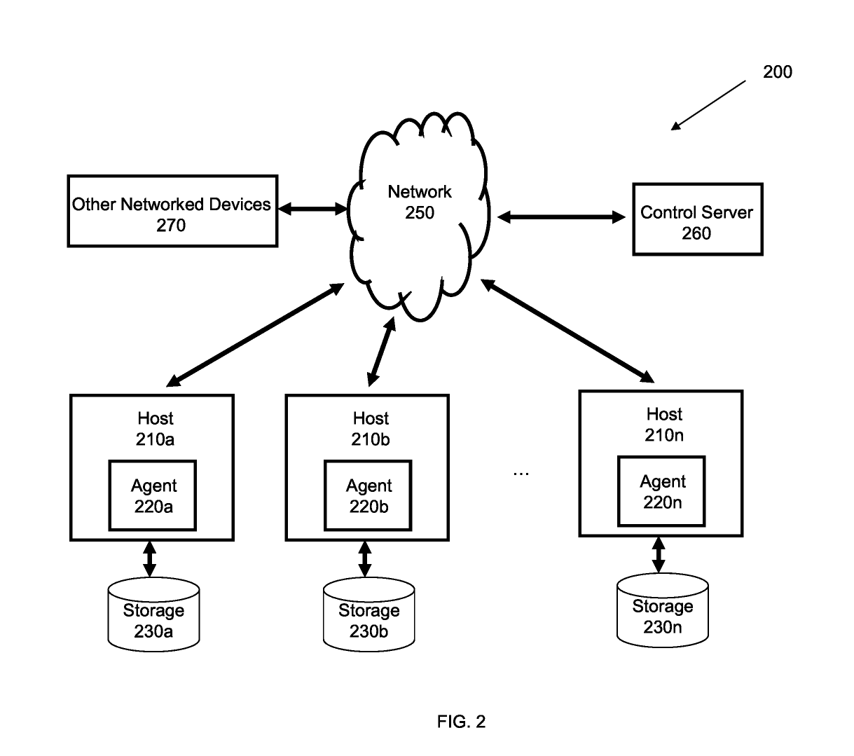

FIG. 2 illustrates a block diagram of a distributed storage system 200 in accordance with certain embodiments of the disclosed subject matter. The distributed storage system 200 can include one or more hosts 210a-n, a network 250, a control server 260, and other networked devices 270. The hosts 210a-n, the control server 260, and other networked devices 270 can both be directly or indirectly coupled to the network 250 and communicate among each other via the network 250, which can be wired, wireless, or a combination of both.

Each host 210, similar to each client 106 illustrated in FIG. 1, can include a desktop computer, a mobile computer, a tablet computer, a cellular device, or any computing systems that are capable of performing computation. The control server 260, as each host 210, can include a desktop computer, a mobile computer, a tablet computer, a cellular device, or any computing systems that are capable of performing computation. Although FIG. 2 shows the server 260 as a single server, the server 260 can include more than one physical or logical servers. The network 250, similar to the communication network 102 illustrated in FIG. 1, can include the Internet, a cellular network, a telephone network, a computer network, a packet switching network, a line switching network, a local area network (LAN), a wide area network (WAN), a global area network, a corporate network, an intranet, a virtual network, or any number of private networks currently referred to as an Intranet, and/or any other network or combination of networks that can accommodate data communication. Such networks may be implemented with any number of hardware and software components, transmission media and network protocols. While FIG. 2 shows the network 250 as a single network, the network 205 can include multiple interconnected networks listed above.

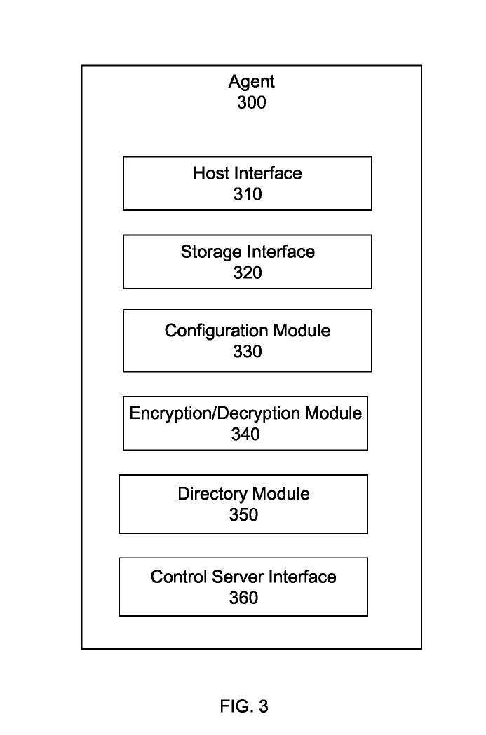

Each host 210 can include an agent 220. The agent 220 can be embedded inside the host 210 as a software module, a hardware component, or a combination of both. Alternatively, the agent 220 can also be separate from but coupled to the host 210. The host 210 can communicate with the control server 260 directly or via its agent 220. Each host 210 can contain a storage 230. The storage 230 can be embedded inside the host 210. Alternatively, the storage 230 can also be separate from but coupled to the host 210. The host 210 can access and/or control the storage 230 directly or via the agent 220. The agent 220 is described more fully below, for example, with respect to FIG. 3.

FIG. 3 illustrates a block diagram of an exemplary agent 300 in a distributed storage system. The agent can be configured to facilitate the storage of information from the network in storage on a specific host 210. For example, the agent can be configured to determine the amount of storage available on the specific host 210 and make that storage available to other devices connected to the network 250 (e.g., the other networked devices 270 or other hosts). The agent can encrypt/decrypt the storage made available to other devices. The agent can communicate with the control server to help configuring the storage made available to other devices.

In particular, the agent 300 can include a host interface 310, a storage interface 320, a configuration module 330, an encryption/decryption module 340, a directory module 350, and a control server interface 360. The agent 300 can communicate with its associated host 210 through the host interface 310. The agent 300 can communicate with the host's associated storage 230 (e.g., hard drive or RAM) through the storage interface 320. The agent 300 can communicate with the control server 260 through the control server interface 360. The configuration module 330 can configure the agent 220, the host 210, and the storage 230 as components of a distributed storage system 200. Configurations and the configuration module 330 in a distributed storage system 200 will be discussed in detail below. The encryption/decryption module 340 can encrypt/decrypt the file/date in the distributed storage system 200 for enhanced security. The directory module 350 can store and maintain a host directory, a file directory, or both. Host directories and file directories will also be discussed in detail below.

A distributed storage system can be controlled by multiple hosts collectively or by a control server centrally. A control server can maintain a policy for the distributed storage system, which can help to configure and customize the distributed storage system. A control server can store and maintain information about the hosts in the distributed storage system. A control server can also provide information about the files/data that are stored on the distributed storage system.

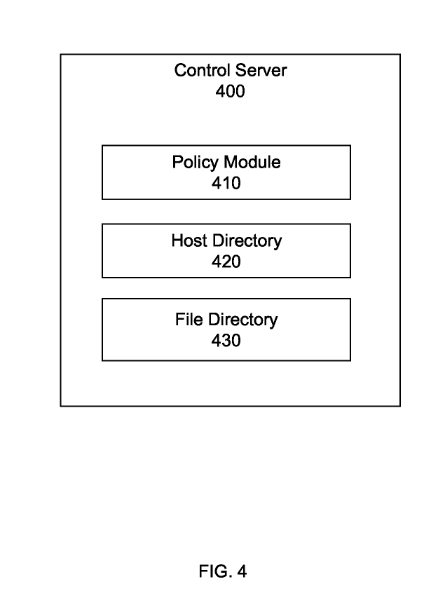

FIG. 4 illustrates a block diagram of an exemplary control server in a distributed storage system. A control server 400 can include a policy module 410, a host directory 420, and a file directory 430. The policy module 410 can manage policy information for the distributed storage system 200. A default policy can be set by an administrator of the distributed storage system. The default policy can be customized to fit the individual needs of each distributed storage system. The customization can be done centrally by the control server 260, by one or more individual hosts 210a-n, or both.

In some embodiments, a policy in the distributed storage system can define the number of participating hosts 210 in the distributed storage system. In one example, a policy can require that every computing device (e.g., desktop computer, etc.) connected to a network (e.g., a corporate intranet) be installed with an agent 220 and serve as a host 210 in the distributed storage system. In another example, a policy can specify that a certain number of, or a certain percentage of computing devices on the network be installed with an agent 220 and serve as a host 210. In yet another example, a policy can allow or disallow a non-host (e.g., other networked devices 270) to access the distributed storage system.

In some other embodiments, a policy in the distributed storage system can define the degree of participation of one or more hosts 210 in the distributed storage system. For example, a policy can specify the amount of storage space that each host 210 must or should contribute to the distributed storage system. Some examples include: “at least 1 GB,” “at most 2 GB,” “at least 10% of available free disk space,” or “at most 20% of available free disk space,” etc. In another example, a policy can require a host 210 to create a separate partition on its disk and make this separate partition available to the distributed storage system. The separate partition can be a physical or logic partition. The separate partition can also be encrypted. A policy can further define if the size of the separate partition is adjustable either manually (e.g., by the administrator of the distributed storage system or by the user of the individual host 210) or automatically (e.g., based on usage and/or availability). A policy can further define if the separate partition must or should be encrypted and, if so, how the encryption must or should be performed.

In some other embodiments, a policy can define the availability of one or more hosts 210. For example, a policy can require that one or more hosts 210 be available (e.g., contributing to the distributed storage system) during certain period of time (e.g., “between 9 am to 5 pm,” “between Monday and Friday,” etc.).

In some other embodiments, a policy can define grouping of available hosts 210. For example, the available hosts 210 on the distributed storage system can be separated into multiple groups. The grouping can be based on various criteria, e.g., departments or function groups within a corporation, physical locations, network topology, etc. Optionally, a policy can further define access levels of hosts 210 within the distributed storage system and/or the groups. In one example, the hosts 210 within a group can be configured to contribute storage space to other hosts 210 within the group, but not to the hosts outside the group. In another example, the hosts 210 within a group can be configured to access the shared storage space contributed by other hosts 210 within the group, but not by the hosts 210 outside the group. In another example, the hosts 210 can be configured to contribute storage space to other participating hosts 210 within the distributed storage system, but not to the non-participating network devices connected to the distributed storage system. Optionally, a policy can further define priority levels of hosts 210 within the distributed storage system and/or the groups. In one example, the hosts 210 within a group can be configured to contribute storage space to other hosts within the group as a first priority, contribute to the hosts 210 outside the group as a second priority, and contribute to other non-participating networked devices as a third priority. A host 210 can belong to one or more groups within the distributed storage system.

In some other embodiments, a policy can define the individual configuration of each host 210 on the distributed storage system. For example, each host 210 can be independently configured to control, for example, 1) whether it is installed with an agent 220 and whether it participates in the distributed storage system 200; 2) when and how it participates in the distributed storage system 200 (e.g., how much storage space to contribute, access level to other host(s) 210 and/or group(s), access level from other host(s) 210 and/or group(s), etc.); 3) whether it belongs to one or more groups; 4) whether to encrypt; etc.

In addition to being managed by the policy module 410 in the control server 410, policy information can be managed individually by each host 210a-n through its configuration module 330. A default policy can be included as a part of the installation of an agent 220a-n. Alternatively, a default policy can be distributed to each host 210 from the control server 260 when each host 210a-n joins the distributed storage system 200. Each host 210a-n can configure its policy and other customizations through its configuration module 330 to fit the needs of each individual host. For example, the user of each host 210 can configure the host through a configuration module 330 as to its storage space contributed (e.g., 1 GB), encryption requirement, access levels, grouping, etc. In some situations, the configuration of each individual host 210 can be subject to and overridden by a centrally controlled policy maintained by a system administrator.

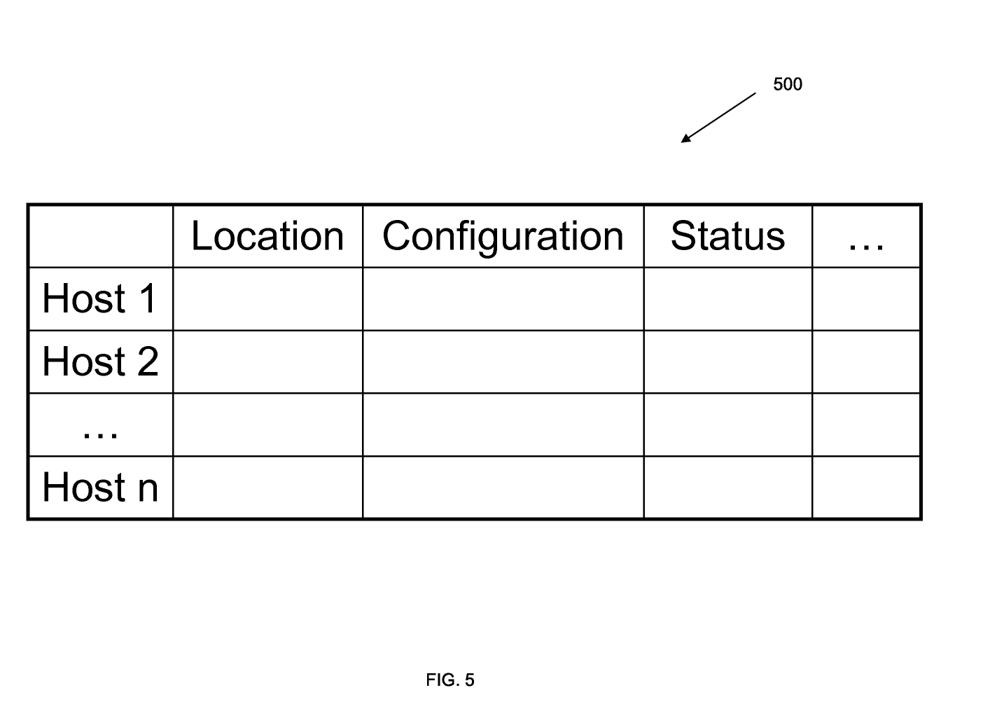

A host directory can help the hosts 210a-n, the central server 260, and other networked devices 270 to locate and identify the hosts in the distributed storage system 200. FIG. 5 illustrates an exemplary host directory 500. For example, the host directory 500 can contain the location, configuration, status, and/or other additional information for each host 210a-n in the distributed storage system 200. The location information can help the distributed storage system locate and identify the host. Some examples of location information include: IP address, MAC address, physical location, subnet information, etc. The configuration information can contain the policy information and other relevant information (e.g., grouping, access levels, availability, etc.) of the host. The status information can indicate the status of the host (e.g., whether the host is currently online, the download/upload bandwidth, firewall protection, encryption status, etc.). Other information can also be stored in the host directory 500.

A centrally stored and maintained host directory 500 (e.g., by the control server 260) can allow for better control and easier maintenance. Alternatively, the host directory 500 can be distributedly stored and managed (e.g., by the directory module 350) on multiple or all hosts 210a-n in the distributed storage system 200. Each host 210 can store and maintain a portion of the host directory 500. A particular portion of the host directory can be stored and maintained by one or more hosts. A host directory 500 that is maintained in a distributed manner can allow for stronger reliability and fault tolerance and better scalability.

A file can contain one or more file fragments. The file fragments of a file can be stored and maintained on one or more hosts 210. In other words, a host 210 can store all of the file fragments making up a file, or only a portion thereof. A file or a file fragment can be redundantly stored on one or more hosts to help improve the reliability, availability, and fault tolerance of the distributed storage system 200.

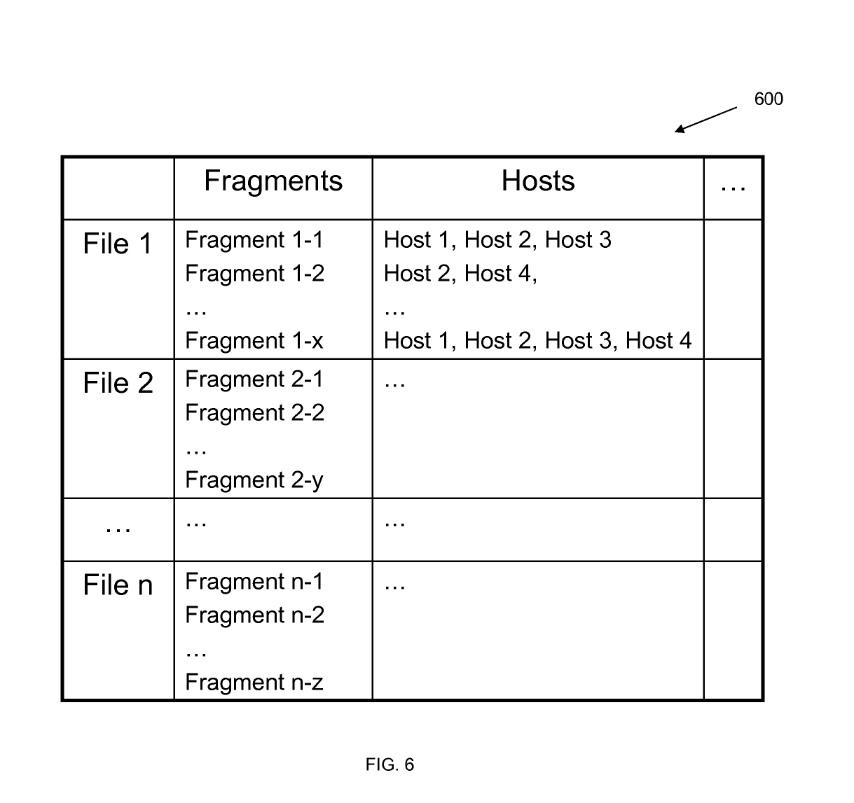

A file directory can help the hosts 210a-n, the central server 260, and other networked devices 270 to locate and identify the files/data stored in the distributed storage system 200. For example, the file directory can function as a road map showing where and how often each file (or portion thereof) is stored in the distributed storage system 200. FIG. 6 illustrates an exemplary file directory 600. The file directory 600 can include the directory information for Files 1-n. File 1 contains x file fragments (Fragment 1-1, 1-2, . . . and 1-x); File 2 contains y file fragments (Fragment 2-1, 2-2, . . . and 2-y); . . . File n contains z file fragments (Fragment n-1, n-2, . . . and n-z). Fragment 1-1 is stored on Host 1, Host 2, and Host 3; Fragment 1-2 is stored on Host 2 and Host 4; . . . Fragment 1-x is stored on Host 1, Host 2, Host 3, and Host 4. In the exemplary scenario illustrated in FIG. 6, when Host 1 goes offline, Host 2 and Host 3 can still make Fragment 1-1 available on the distributed storage system 200; when Host 2 goes offline, Host 4 can still make Fragment 1-2 available on the distributed storage system 200.

A centrally stored and maintained file directory 600 (e.g., by the control server 260) can allow for better control and easier maintenance. Alternatively, a file directory 600 can be distributedly stored and managed (e.g., by the directory module 350) on multiple or all hosts 210a-n in the distributed storage system 200. Each host can store and maintain a portion of the file directory 500. A particular portion of the file directory can be stored and maintained by one or more hosts. A distributedly stored and maintained file directory can increase reliability, availability, and scalability.

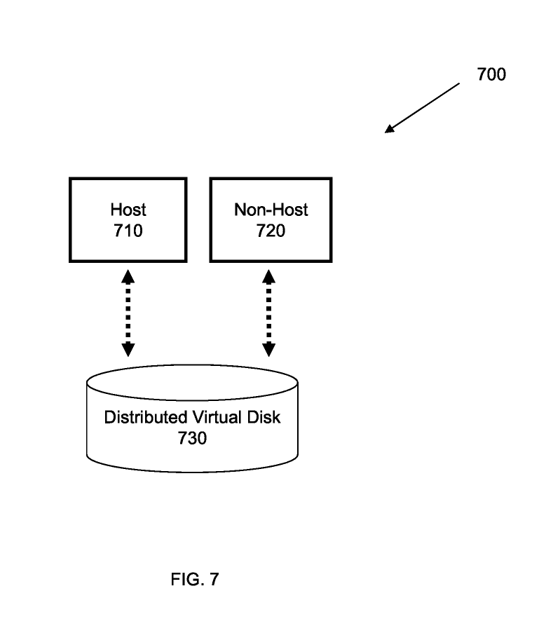

From the prospective of each host, the distributed storage system can function as a regular storage device (e.g., a hard disk). As illustrated in FIG. 7, a distributed storage system 700 can present a distributed virtual disk 730 to a host 710 and a non-host 720. The host 710 or non-host 720 can access (e.g., read, write, update, etc.) the distributed virtual disk 730 as any regular storage devices, subject to the configuration or the policy (e.g., access levels) of the distributed storage system 700. The physical configurations and components of the distributed virtual disk 730 can be transparent to the host 710 and non-host 720. Each host can contribute to the distributed virtual disk 730 some free storage space, which can otherwise be un-utilized or under-utilized. The distributed virtual disk 730 can provide storage resources to various devices (either a host 710 or non-host 720) within a network (e.g., a corporate intranet). When the distributed storage system is implemented inside a corporate network, the corporation can reduce the cost and resources of purchasing and maintaining dedicated storage hardware (e.g., in NAS or SAN).

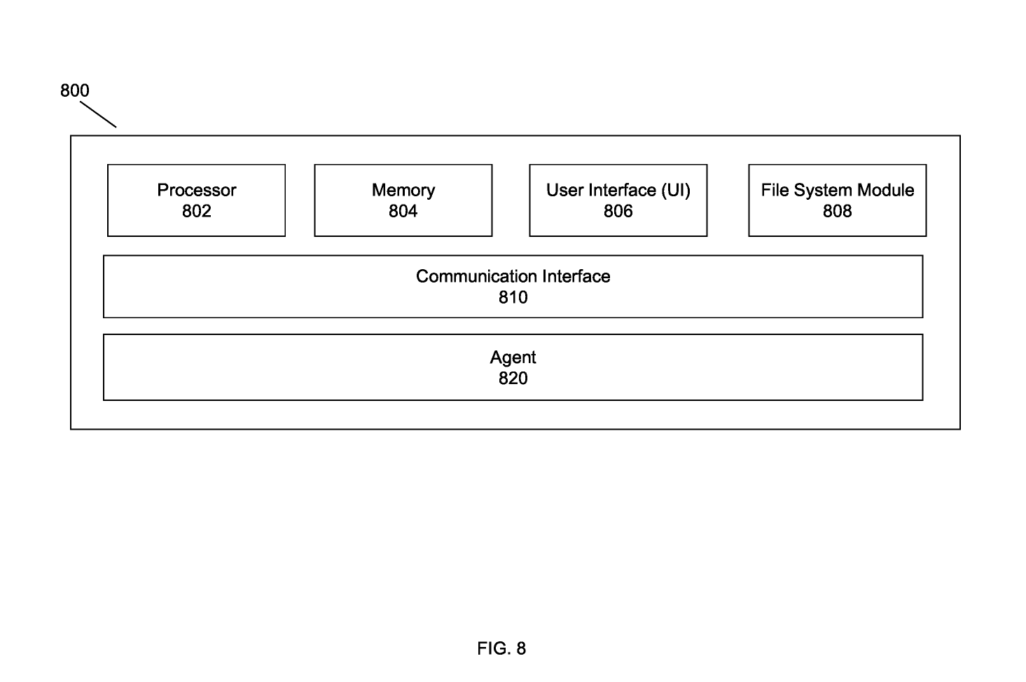

FIG. 8 illustrates a block diagram of a computing system that can be used to implement one or more aspects of the functionality described herein. The computing system 800 can serve as, for example, a client 106, a server 104, or both in the networked communication arrangement 100. The computing system 800 can also serve as, for example, a host 210, a control server 260, or both in the distributed storage system 200. The computing system 800 can include at least one processor 802 and at least one memory 804. The processor 802 can be hardware that is configured to execute computer readable instructions such as software. The processor 802 can be a general processor or be an application specific hardware (e.g., an application specific integrated circuit (ASIC), programmable logic array (PLA), field programmable gate array (FPGA), or any other integrated circuit). The processor 802 can execute computer instructions or computer code to perform desired tasks. The memory 804 can be a transitory or non-transitory computer readable medium, such as flash memory, a magnetic disk drive, an optical drive, a programmable read-only memory (PROM), a read-only memory (ROM), or any other memory or combination of memories.

The computing system 800 can also optionally include a user interface (UI) 806, a file system module 808, and a communication interface 810. The UI 806 can provide an interface for users to interact with the computing system 800 in order to access the distributed storage system. The file system module 808 can be configured to maintain a list of all data files, including both local data files and remote data files, in every folder in a file system. The file system module 808 can be further configured to coordinate with the memory 804 to store and cache files/data. The communication interface 810 can allow the computing system 800 to communicate with external resources (e.g., a network or a remote client/server). The computing system 800 can also include an agent 820. The description of the agent 820 and its functionalities can be found in the discussion of FIGS. 2-7. The computer system 800 can include additional modules, fewer modules, or any other suitable combination of modules that perform any suitable operation or combination of operations.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

A “server,” “module,” and “host” is not software per se and includes at least some tangible, non-transitory hardware that is configured to execute computer readable instructions.

What is claimed is:

1. A distributed storage system, comprising:
a control server coupled to a network, the control server maintaining a policy, a host directory, and a file directory; and
a plurality of hosts coupled to the network, each of the plurality of hosts containing a storage device and an agent configured to communicate with the control server,
wherein each of the plurality of hosts is configured to contribute a portion of the storage device thereof to collectively form a distributed virtual disk configured to store files,
wherein the portion of the storage device on each of the plurality of hosts is configured based on the policy,
wherein the host directory contains information about the plurality of the hosts on the distributed storage system, and
wherein the file directory contains information about the files stored on the distributed storage system.

2. The distributed storage system of claim 1, wherein the portion of the storage device on each of the plurality of hosts is a separate partition of the storage device.

3. The distributed storage system of claim 1, wherein the policy defines a size of the portion of the storage device on each of the plurality of hosts.

4. The distributed storage system of claim 3, wherein the policy further defines whether the size of the portion of the storage device on each of the plurality of hosts is adjustable.

5. The distributed storage system of claim 1, wherein the policy defines an availability of each of the plurality of hosts on the distributed storage system.

6. The distributed storage system of claim 1, wherein the policy defines access levels among the plurality of hosts on the distributed storage system.

7. The distributed storage system of claim 1, wherein at least some of the plurality of hosts on the distributed storage system are separated into one or more groups.

8. The distributed storage system of claim 7, wherein the policy defines access levels among the plurality of hosts according to group affiliation information.

9. A control server for use with a distributed storage system that includes a network and a plurality of hosts, each host including a storage device and an agent, the control server comprising:
a non-transitory memory storing computer readable instructions, a policy, a host directory, and a file directory; and
a processor coupled to the non-transitory memory and configured to execute the computer readable instructions;
wherein the computer readable instructions are configured to cause the control server to communicate with the agent in each of the plurality of hosts coupled to the network,
wherein the computer readable instructions are configured to cause the control server to communicate the policy to the plurality of hosts in order to configure the plurality of hosts,
wherein the computer readable instructions are configured to cause the control server to receive an indication from each of the plurality of hosts of a portion of the storage device thereof that is available to form a distributed virtual disk for storing files on the distributed storage system,
wherein the host directory contains information about the plurality of the hosts in the distributed storage system, and
wherein the file directory contains information about the files stored on the distributed storage system.

10. The control server of claim 9, wherein the policy defines a size of the portion of the storage device on each of the plurality of hosts.

11. The control server of claim 10, wherein the policy further defines whether the size of the portion of the storage device on each of the plurality of hosts is adjustable.

12. The control server of claim 9, wherein the policy defines an availability of each of the plurality of hosts in the distributed storage system.

13. The control server of claim 9, wherein the policy defines access levels among the plurality of hosts in the distributed storage system.

14. The control server of claim 9, wherein the policy defines group affiliation of at least some of the plurality of hosts in the distributed storage system.

15. The control server of claim 14, wherein the policy further defines access levels among the plurality of hosts based on the group affiliation.

16. A host for use with a distributed storage system that includes a control server coupled to a network, the host comprising:
a storage device;
a non-transitory memory storing computer executable instructions; and
a processor coupled to the non-transitory memory and configured to execute the computer readable instructions;
wherein the computer readable instructions are configured to cause the host to communicate with the control server,
wherein the computer readable instructions are configured to cause the processor to configure the host based on a policy received from the control server, and
wherein the computer readable instructions are configured to cause the host to send an indication to the control server of a portion of the storage device thereof that is available to form a distributed virtual disk for storing files on the distributed storage system.

17. The host of claim 16, wherein the computer readable instructions are configured to cause the processor to set a size of the portion of the storage device based on the policy.

18. The host of claim 17, wherein the computer readable instructions are configured to cause the processor to further set adjustability of the size of the portion of the storage device based on the policy.

19. The host of claim 16, wherein the computer readable instructions are configured to cause the processor to set availability of the host in the distributed storage system based on the policy.

20. The host of claim 16, wherein the computer readable instructions are configured to cause the processor to set access levels of the host in the distributed storage system based on the policy.

21. The host of claim 16, wherein the computer readable instructions are configured to cause the processor to set group affiliation of the host within the distributed storage system based on the policy.

22. The host of claim 21, wherein the computer readable instructions are configured to cause the processor to further set access levels according to the group affiliation based on the policy.

23. A non-transitory computer readable medium having executable instructions operable to, when executed by a computer, cause the computer to:
configure a portion of a storage device of the computer based on a policy maintained by a control server, wherein the control server is coupled to a network and communicates with a plurality of hosts through the network; and
contribute the portion of the storage device to form a distributed virtual disk to the plurality of hosts for storing files on a distributed storage system.
